(19) United States
(12) Patent Application Publication
(10) Pub. No.: US 2013/0081567 A1
(43) Pub. Date: Apr. 4, 2013

(54) Roadside Motor Vehicle Emergency Marker with Information Display

(71) Applicant: Lee Lawrence Goodwyn, JR., Alexandria, VA (US)

(72) Inventor: Lee Lawrence Goodwyn, JR., Alexandria, VA (US)

(21) Appl. No.: 13/252,209

(22) Filed: Oct. 4, 2011

(51) Int. Cl. B60Q 1/52

(52) U.S. Cl. 116/28 R

(57) ABSTRACT

The present invention is a roadside motor vehicle emergency marker. The marker includes an attachment member, a base, marker body, and a message sleeve. The attachment member positions the marker on a motor vehicle component. The base, projects the reflective marker body beyond the motor vehicle to alert passersby. The reflective marker body includes a sleeve and reservoir to contain, display, and protect information pertinent to the motor vehicle's condition.

### FIELD OF THE INVENTION

The present invention relates to the field of roadside markers and more specifically to the field of roadside motor vehicle emergency markers that can contain, display, and protect information relating to a motor vehicle's condition.

### BACKGROUND

Each year many motor vehicles break down or fail on the road or on the side of the road each year. When a motor vehicle breaks down a person usually has to leave it to get help or leave to come back to the motor vehicle at a later time. In this case people usually place a rag in the window to indicate to others that their motor vehicle is in a broken down or failed state. A rag is also left to indicate to people who pass by to know that there is an emergency or potential emergency regarding the vehicle that the rag is on. For a number of very significant reasons people leave information at the scene of the motor vehicle emergency. When a person leaves their motor vehicle they often leave a sticky note (such as a “post it” note) or a piece of paper with writing on it attached to the motor vehicle. One reason is because they want to leave information behind in case someone stops by to offer help. Another reason is because they wish to leave information behind for a towing truck that is coming to get the motor vehicle. People can also leave information behind while they leave their vehicle so they can provide emergency information for the authorities in case they visit and inspect the motor vehicle or scene around it while they are gone. This can provide assurance to the person who motor vehicle has failed because they feel that the chances of their motor vehicle being towed or carried away in their absence will be significantly reduced. These are just some among many reasons why someone chooses to leave information behind at the scene of a motor vehicle breakdown.

There are many disadvantages to placing a sticky note, post it note, or paper message on the motor vehicle. At the time of motor vehicle breakdown some people do not have a paper or a writing utensil on hand at all. For those who do there are a number of things that can happen to the message they leave. The message can easily fall or fly off the car. The weather can put it through elements (such as rain) which can cause the message to fade or become unreadable. Plus the common rag that may be found or carried around the motor vehicle (if any) doesn't provide the best surface or material for writing and displaying a message on for others to see. Leaving no information at the scene of the motor vehicle emergency or breakdown could have serious consequences.

Some people travel and have no rag or rag type item in their vehicle at all so they are not able to give any type of signal or indicator of their situation. There is a chance were just leaving a rag in the window may be not be seen too well. The chances of people who pass by not seeing it lower as nighttime approaches. If the rag happens to be a darker color the chances of it being seen decrease even more. The darker the rag the less visible it is at night and the chances of people seeing that the motor vehicle is in an emergency state is reduced.

Additionally sometimes the motor vehicle may be in a state where it will not allow the window to operate enough to put and place a rag to it. This could be because the user has a motor vehicle window that is broken, misaligned, or stuck. There could also be a scenario were the motor vehicle power shuts down and doesn't allow the user to slide down the window at all. There are other situations where people can't place anything on their window because they have a window that is broken and have plastic covered over it secured by tape.

There are a couple of items that attempt to address the problem of providing a motor vehicle emergency marker in motor vehicle breakdown or failure situations. One is a rag which was spoken to above. Two is the commercially available triangle emergency marker. While they provide the user something to indicate an emergency or distressing motor vehicle situation to others they have disadvantages. Both rags and current vehicle emergency markers do not have an information display function or feature that allows the user to leave specific details of the situation or information on the scene for then they leave the motor vehicle. These items also do not have any way of storing and protecting information left at the scene. Current vehicle emergency markers are also limited to either being mounted or placed onto the side window of a vehicle or on the ground. This can become a significant disadvantage in if a user's window is in a state like mentioned previously.

Today people who have a motor vehicle emergency or encounter motor vehicle problem still have to place information somewhere on the scene separately of the marker. Also a user can be at a disadvantage with current products that attempt to address the solution because they are limited to using the product via the side window or the ground. As mentioned previously there can be a scenario where the window has limited or no function at all. Plus placing the marker on the ground can leave the marker prone to be knocked over, blown away, stolen, etc.

Therefore, there is a need for an apparatus that:
provides a marker for roadside motor vehicle emergencies that can contain, display, and protect information the user needs to leave regarding the situation.
provides a marker for roadside motor vehicle emergencies that is not limited to use with an motor vehicle window.
provides a marker for roadside motor vehicle emergencies that is not limited to use on the ground.
provides a marker for roadside motor vehicle emergencies that can hold and store a writing utensil and a piece of material that can be written on for use when a user needs to leave information at he scene of the roadside motor vehicle emergency.

### SUMMARY

The present invention is a roadside motor vehicle emergency marker with information display. The marker includes an attachment member, a base, marker body, and a message sleeve. The attachment member positions the marker on a motor vehicle component. The base, projects the reflective marker body beyond the motor vehicle to alert passersby. The reflective marker body includes a sleeve and reservoir to contain, display, and protect information pertinent to the motor vehicle's condition.

Therefore, it is an aspect of the present invention to provide a marker for roadside motor vehicle emergencies that can contain, display, and protect information the user needs to leave regarding the situation.

It is a further aspect of the present invention to provide a marker for roadside motor vehicle emergencies that is not limited to use with a motor vehicle window.

It is still a further aspect of the present invention to provides a marker for roadside motor vehicle emergencies that is not limited to use on the ground.

It is still a further aspect of the present invention to provide a marker for roadside motor vehicle emergencies that can hold and store a writing utensil and a piece of material that can be written on for use when a user needs to leave information at he scene of the roadside motor vehicle emergency.

These aspects of the invention are not meant to be exclusive. Furthermore, some features may apply to certain versions of the invention, but not others. Other features, aspects, and advantages of the present invention will be readily apparent to those of ordinary skill in the art when read in conjunction with the following description, and accompanying drawings.

### BRIEF DESCRIPTION OF THE DRAWINGS

FIG. 1 shows a perspective, front view of the roadside motor vehicle emergency marker with information display 100.

FIG. 1A shows a perspective, back view of the roadside motor vehicle emergency marker with information display 100.

FIG. 1B shows a perspective view of the roadside motor vehicle emergency marker with information display 100.

FIG. 1C shows a side sectional view of what is depicted in FIG. 1B.

FIG. 1D shows a perspective view of the roadside motor vehicle emergency marker with information display 100 in use in a motor vehicle window.

FIG. 1E shows a perspective view of the roadside motor vehicle emergency marker with information display 100 in use with a motor vehicle wheel.

FIG. 1F shows a another perspective view of the roadside motor vehicle emergency marker with information display 100 in use with a motor vehicle wheel.

FIG. 1G shows a perspective view of the roadside motor vehicle emergency marker with information display 100 in use in a motor vehicle door

FIG. 1H shows a perspective view of the roadside motor vehicle emergency marker with information display 100 in use in the opening between the motor vehicle outside window and the door.

FIG. 1I shows a perspective view of the roadside motor vehicle emergency marker with information display 100 in use with a license plate of the motor vehicle.

FIG. 1J shows a perspective view of the roadside motor vehicle emergency marker with information display 100 in use in a motor vehicle door.

FIG. 2 shows a perspective, front view of another version of the roadside motor vehicle emergency marker with information display 100.

FIG. 2A shows a perspective, back view of another version of the roadside motor vehicle emergency marker with information display 100.

FIG. 2B shows a perspective view of a portion of another version of the roadside motor vehicle emergency marker with information display 100.

FIG. 2C show a side sectional view of what is depicted in FIG. 2B.

FIG. 2D shows a perspective view of a portion of another version of the roadside motor vehicle emergency marker with information display 100.

FIG. 2E shows a perspective view of a portion of another version of the roadside motor vehicle emergency marker with information display 100.

FIG. 2F shows a side sectional view of what is depicted in FIG. 2E.

FIG. 2G shows a perspective, inside view of the marker body second layer of the roadside motor vehicle emergency marker with information display 100.

FIG. 3 shows a perspective view of the end opposite of the marker body end of the roadside motor vehicle emergency marker with information display 100.

FIG. 4 shows a perspective, front view of another version of the roadside motor vehicle emergency marker with information display 100.

FIG. 4A shows a perspective, back view of another version of the roadside motor vehicle emergency marker with information display 100.

FIG. 4B shows a perspective view of another version of the roadside motor vehicle emergency marker with information display 100.

FIG. 4C shows a perspective view of another version of the roadside motor vehicle emergency marker with information display 100 in use in a motor vehicle window.

FIG. 4D shows a perspective view of another version of the roadside motor vehicle emergency marker with information display 100 in use with a motor vehicle wheel.

FIG. 4E shows a another perspective view of another version of the roadside motor vehicle emergency marker with information display 100 in use with a motor vehicle wheel.

FIG. 4F shows a perspective view of another version of the roadside motor vehicle emergency marker with information display 100 in use in a motor vehicle door.

FIG. 4G shows a perspective view of another version of the roadside motor vehicle emergency marker with information display 100 in use in a motor vehicle door.

FIG. 5 shows a perspective, front view of another version of the roadside motor vehicle emergency marker with information display 100.

FIG. 5A shows a perspective, back view of another version of the roadside motor vehicle emergency marker with information display 100.

FIG. 5B shows a perspective view of a portion of another version of the roadside motor vehicle emergency marker with information display 100.

FIG. 5C shows a perspective view of a portion of another version of the roadside motor vehicle emergency marker with information display 100.

FIG. 5D shows a perspective view of another version of the roadside motor vehicle emergency marker with information display 100.

### DETAILED DESCRIPTION

DEFINTIONS

Selfseal—Any device that can seal without the help of any third party
component.

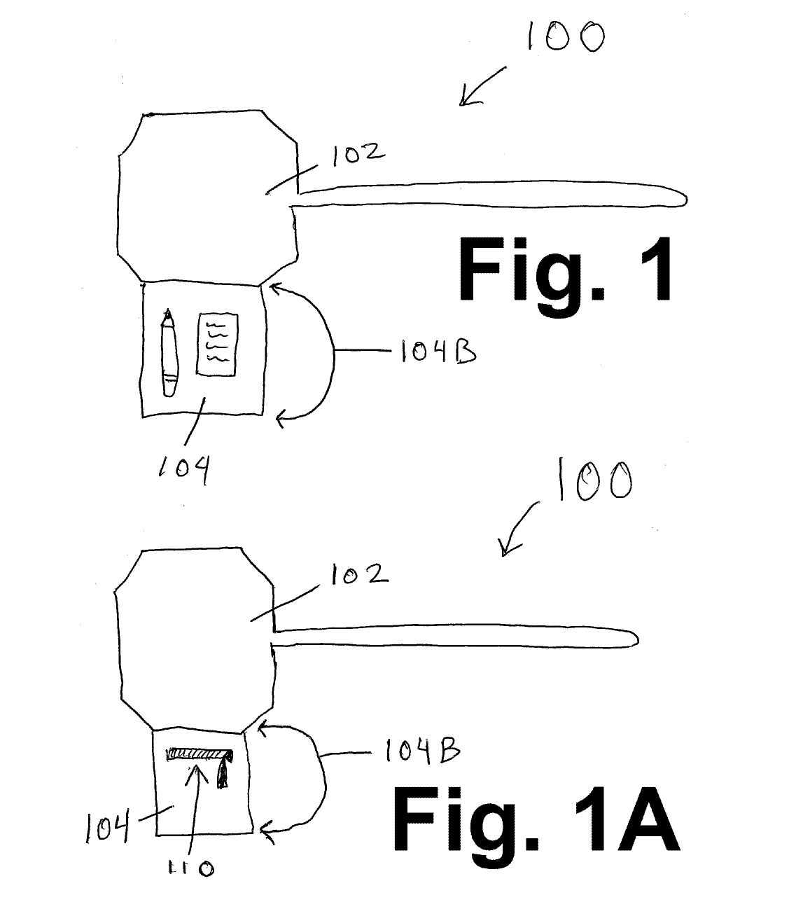

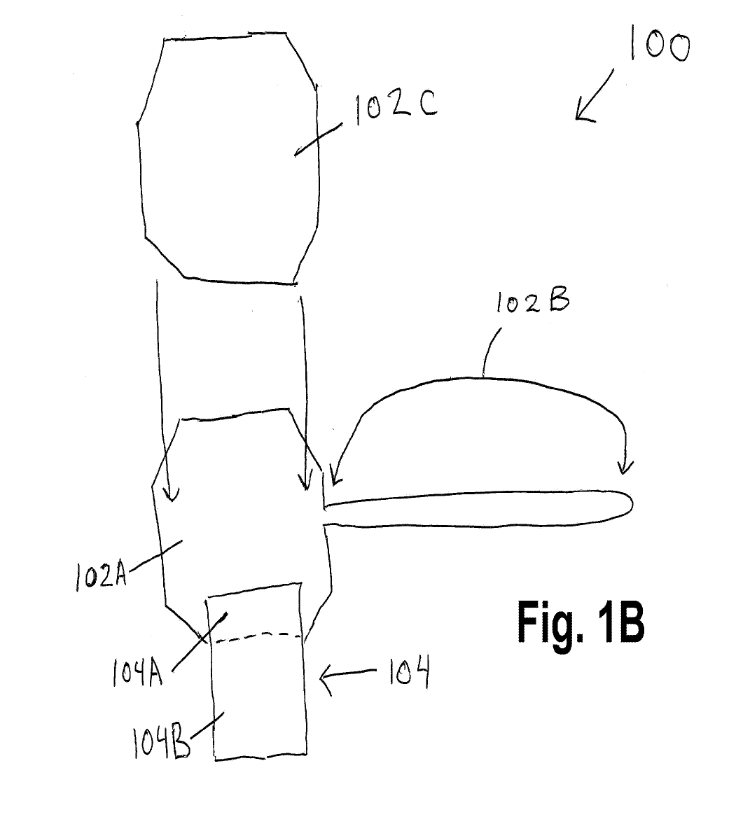

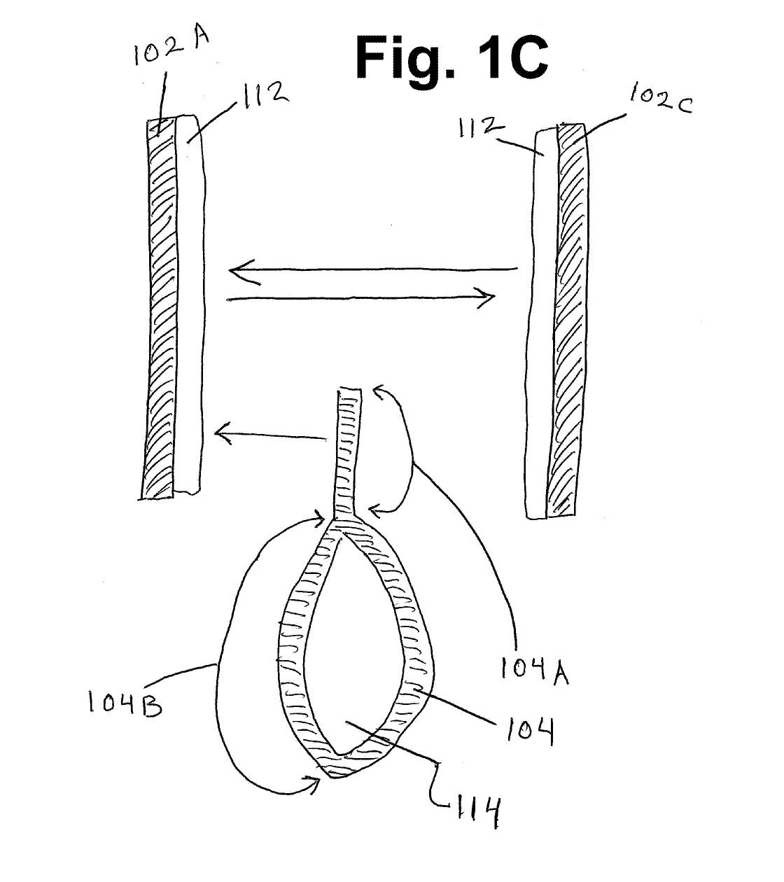

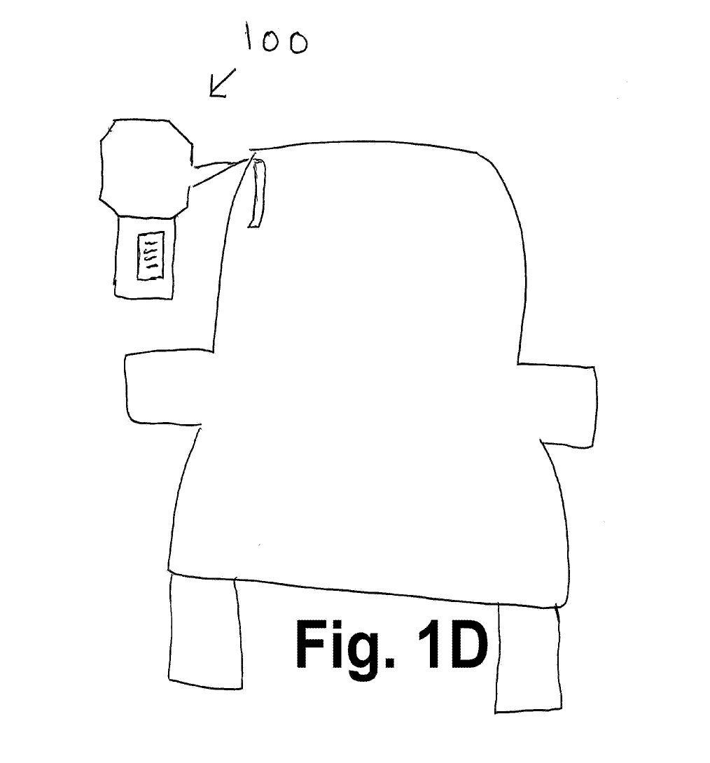

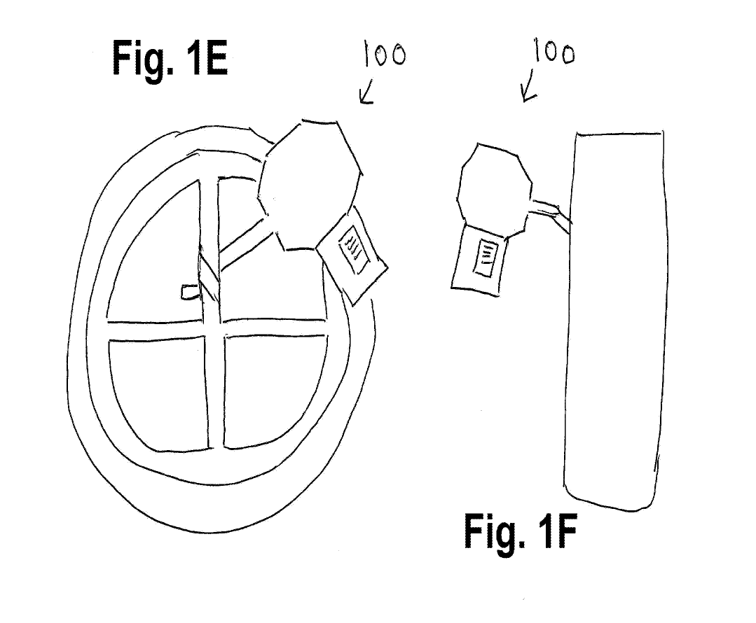

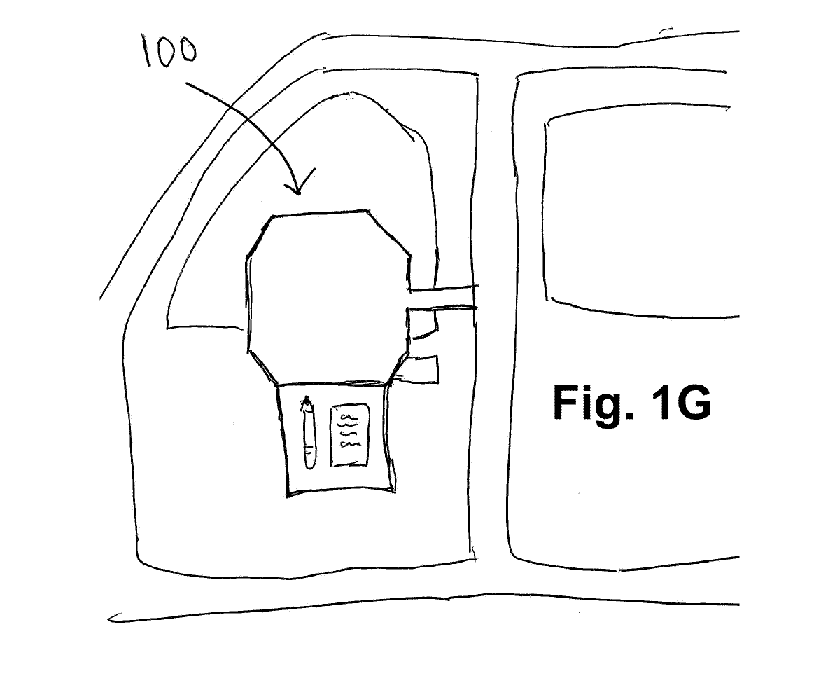

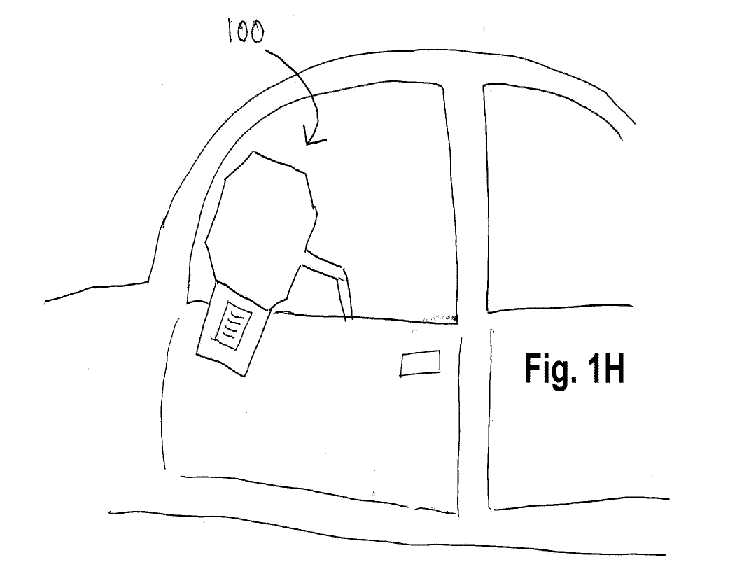

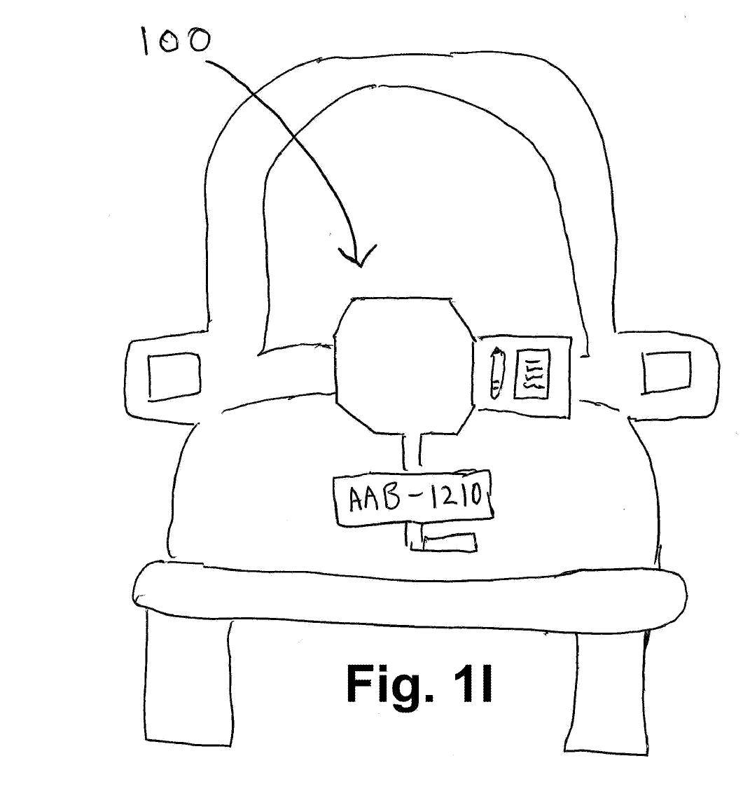

FIG. 1 through FIG. 1J shows the roadside motor vehicle emergency marker with information display 100.

The roadside motor vehicle emergency marker with information display 100 comprises a marker 102 and a message sleeve 104. The marker 102 comprises of a marker body 102A, elongate marker base and attachment member 102B, and a marker body second layer 102C. The inside of the marker body second layer 102C is applied to the inside of the marker body 102A. The top flat portion 104A of the message sleeve 104 is held and bonded in between the marker body 102A and the marker body second layer 102C. The marker body 102A, marker body second layer 102C, and the top flat portion 104A of the message sleeve 104 is held in between with adhesive 112 such as glue.

The marker body 102A and the marker body second layer 102C are preferably of identical in shape and size. They are both preferably have an eight sided square shape but can be a plurality of shapes. They are both of preferably identical shapes and sizes so they can comprise a marker body that is of uniform shape. Even though this is preferred they can have shapes or sizes that are not identical. The marker body second layer 102C is to be applied to the inside of the marker body 102A and the side opposite the top flat portion 104A of the message sleeve 104 that is bonded to the marker body 102A.

The marker 102 is made preferably of a plastic material but can be made of a plurality of materials. This material of the marker 102 has reflective surfaces. This could be achieved by the application of a commercially reflective tape or the like to the surface of the marker 102. They can preferably have bright colors but are not limited to these colors.

The elongate marker base and attachment member 102B portion of the marker 102 comprises a rod. One end of the rod would be bonded in between the market body 102A and the market body second layer 102C. Rods commercially available may apply the present invention, including those constructed of metal, plastic, wood, and the like. Metal rods would be used in embodiments of the present invention desiring rigidity and longevity. Plastic rods would be used in embodiment of the present invention desiring flexibility in use and simplicity in construction. Wooden rods may appeal to embodiments of the present invention achieving cost or design objectives. One end of the rod would be bonded in between the market body 102A and the marker body second layer 102C.

The message sleeve 104 is made preferably of a transparent plastic material but can be made of a plurality of materials. The message sleeve 104 is preferably the shape of a bag. The message sleeve 104 comprises of a top flat portion 104A and a bottom container portion 104B. One side of the sleeve has a selfseal 110, which preferably is a zipper but can be a plurality of selfseals (such as button or Velcro). The selfseal 110 is located on the bottom container portion 104B of the message sleeve 104. The message sleeve 104 serves to contain, display, and protect information that is placed within it. The bottom container portion 104B of the message sleeve 104 has an opening 114 which holds the information. The top flat portion 104A of message sleeve 104 fits in between the marker body 102A and the marker body second layer 102C and held by adhesive 112. The message sleeve 104 is preferably located one of the sides of the marker body that doesn't directly have the elongate marker base and attachment member 102B on it.

When there is a roadside motor vehicle emergency a user can use the present invention by placing information or their message into message sleeve 104. After this the user then attaches and affixes the elongate marker base and attachment member 102B to the motor vehicle component of their choice. They then can position the marker body (which is the marker body 102A and marker body second layer 102C bonded together) with attached message sleeve 104 at an angle of their choice. The reflective sides make the marker highly visible to the people who pass by, especially in the darker times of the day. When people pass by they are alerted to the motor vehicle emergency and if they choose they can go check the information or message that is contained in the message sleeve 104. The passerby can also choose to drop a message in the message sleeve 104 also. The present invention allows the user to leave information or a message at the scene of the motor vehicle emergency and have it protected from blown away in the wind, ruined by the rain, or other scenarios. It also allows the user to place the marker in plurality of places other than on the motor vehicle window or on the ground.

Some of the advantages of the roadside motor vehicle emergency marker with information display 100 include:
providing a marker for roadside motor vehicle emergencies that can contain, display, and protect information the user needs to leave regarding the situation.
providing a marker for roadside motor vehicle emergencies that is not limited to use with a motor vehicle window.
providing a marker for roadside motor vehicle emergencies that is not limited to use on the ground.
providing a marker for roadside motor vehicle emergencies that can hold and store a writing utensil and a piece of material that can be written on for use when a user needs to leave information at he scene of the roadside motor vehicle emergency.

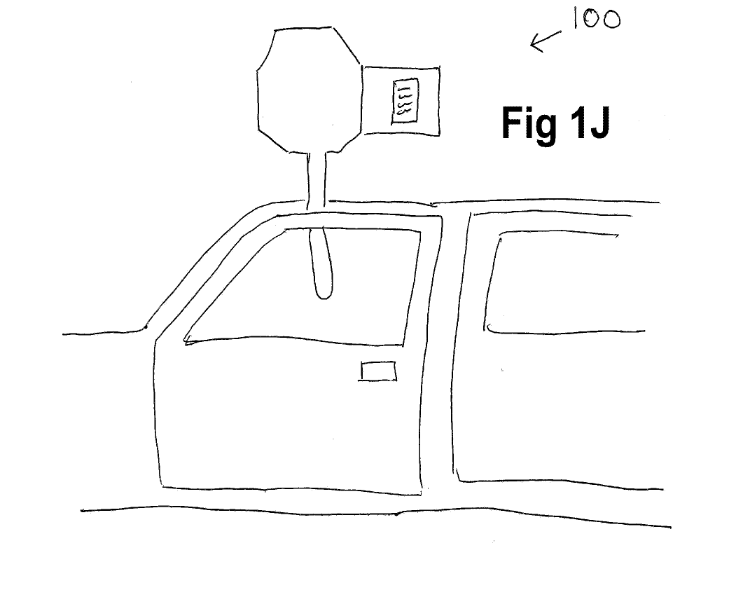

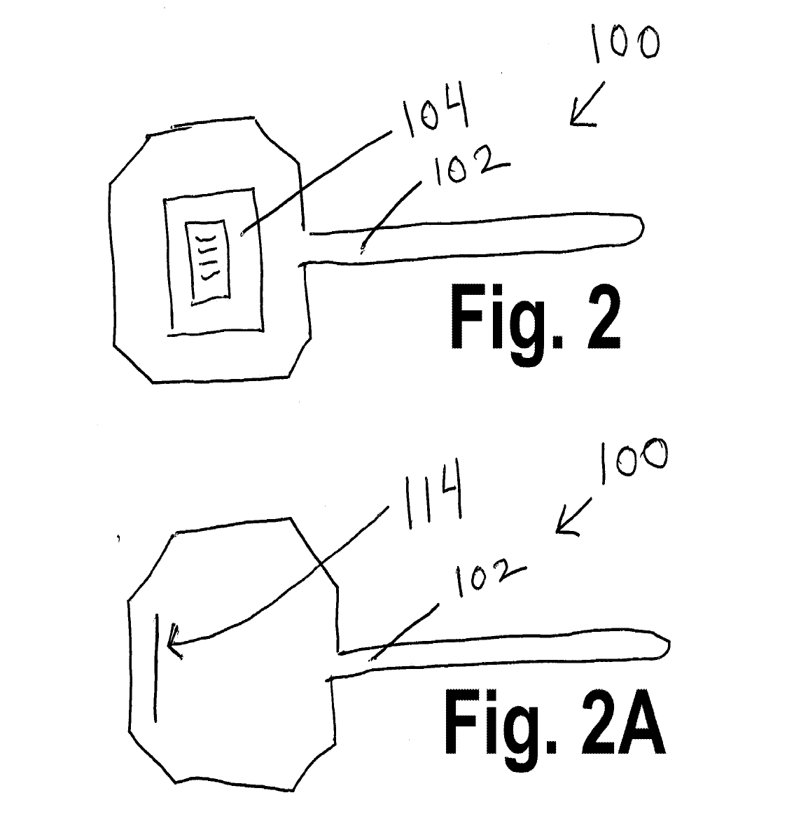

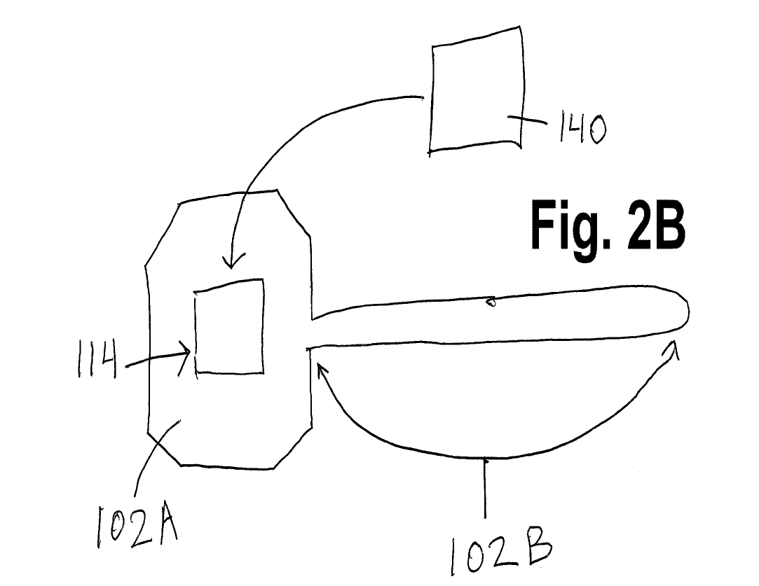

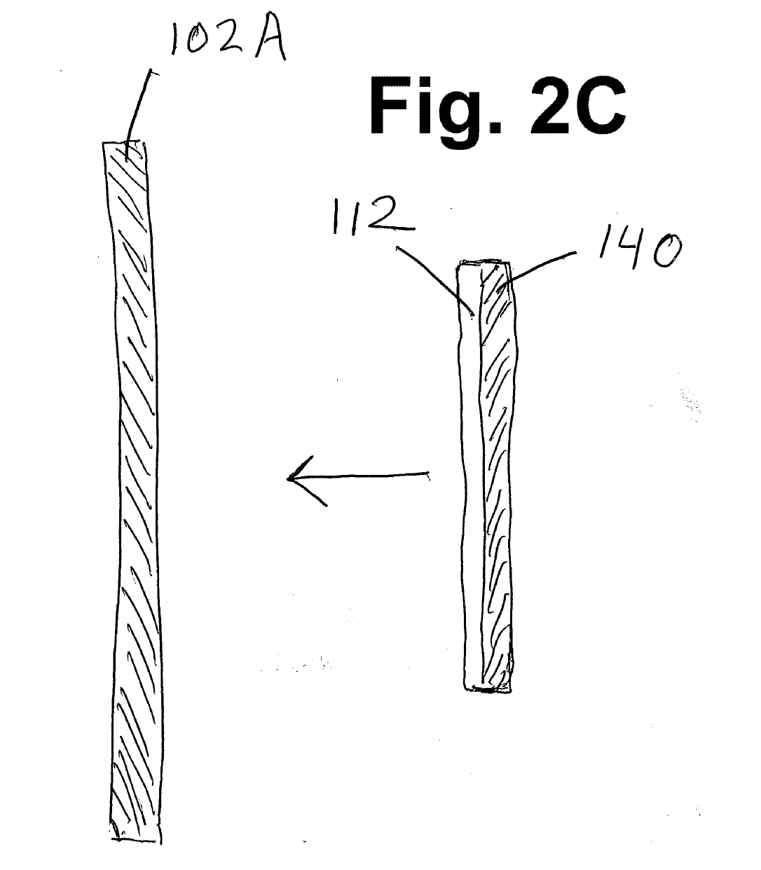

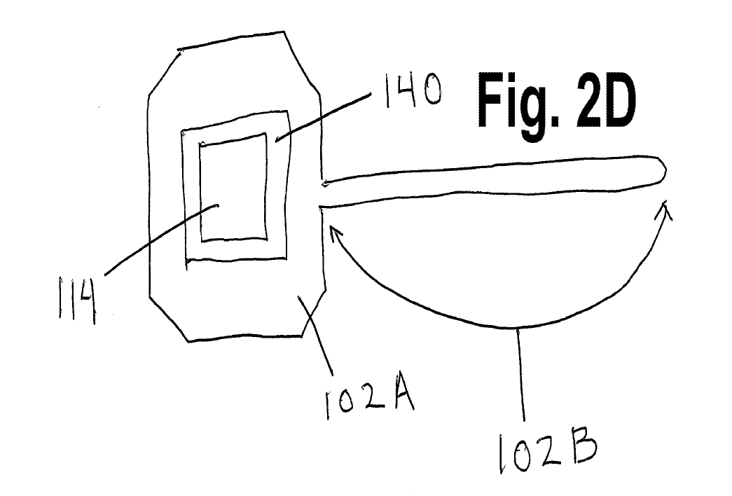

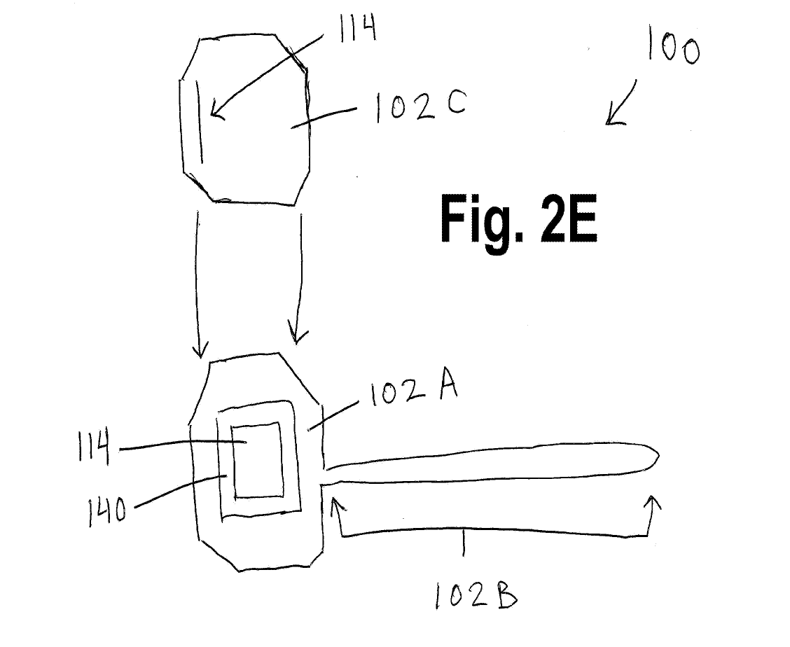

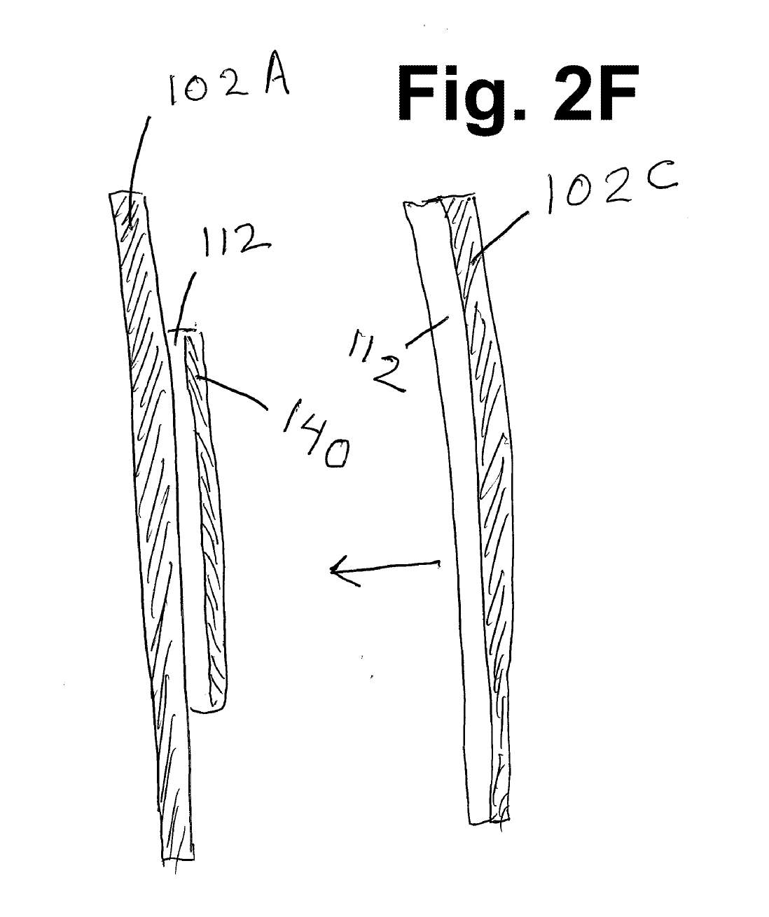

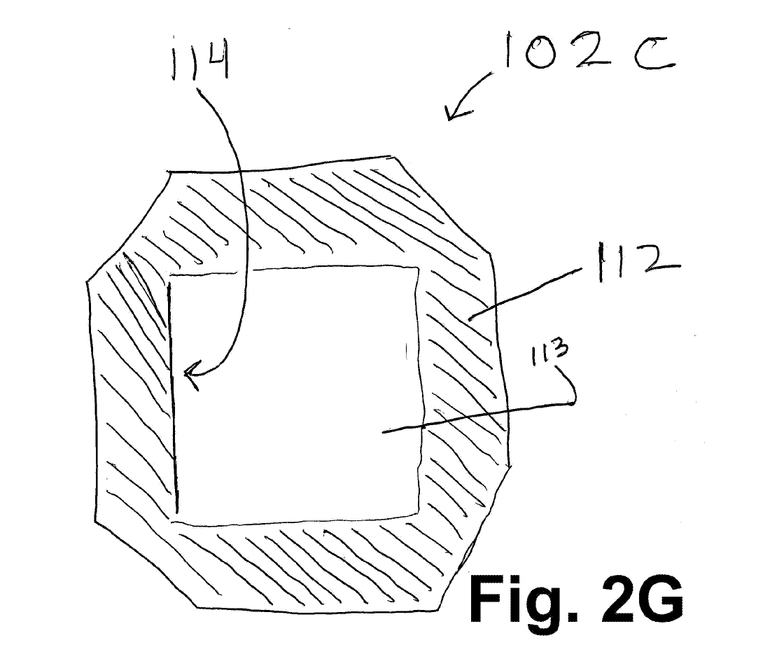

Another version of the roadside motor vehicle emergency with information display 100 is shown in FIG. 2 through FIG. 2G. This version is very similar to the above discussed version but the entire message sleeve 104 is located within the marker body 102A and the marker body second layer 102C of the marker 102. This version of the roadside motor vehicle emergency marker with information display 100 comprises a marker 102 and a message sleeve 104. The marker 102 comprises of a marker body 102A with opening 144, elongate marker base and attachment member 102B, and a marker body second layer 102C. A screen 140 is placed over the opening 114 over the marker body 102A. The outside area of the screen 140 is bonded around the opening 114 of the marker body 102A by an adhesive 112 such as glue. The inside of the marker body second layer 102C is then applied to the inside of the marker body 102A which already has the screen 140 applied to it.

The marker body second layer 102C has a slit like opening 114 near to one side of it. This opening 114 is preferably located near the side opposite the side that will directly contact and line up with the side of the marker body 102A with the elongate marker base and attachment member 102B. The slit like opening 114 is runs parallel to this side. An adhesive 112 preferably glue is applied to the inside of the marker body second layer 102C with opening 114. The adhesive 112 is preferably applied to the outside area of the inner side of the marker body second layer 102C with opening 114 which leaves a non adhesive section 113 located in the middle. The opening 114 serves as a border of one side of this non adhesive section 113. This non adhesive section 113 covers the area of the screen 140 that is bonded to the marker body 102A.

Once the marker body second layer 102C with opening 114 is applied to the marker body 102A with opening 114 with screen 140 as discussed with this version (version pertaining to FIG. 2 through FIG. 2G) a marker 102 with message sleeve 104 is provided. The user can then place the message in the slit like opening 114 of the back and it will be held within the non adhesive portion 113 and screen 140 area of the inside. The screen 140 then displays the information or message that is placed within it. After the user places the information within the marker body the plastic material of the marker body allows the body to collapse back and the slit like opening 114 to close.

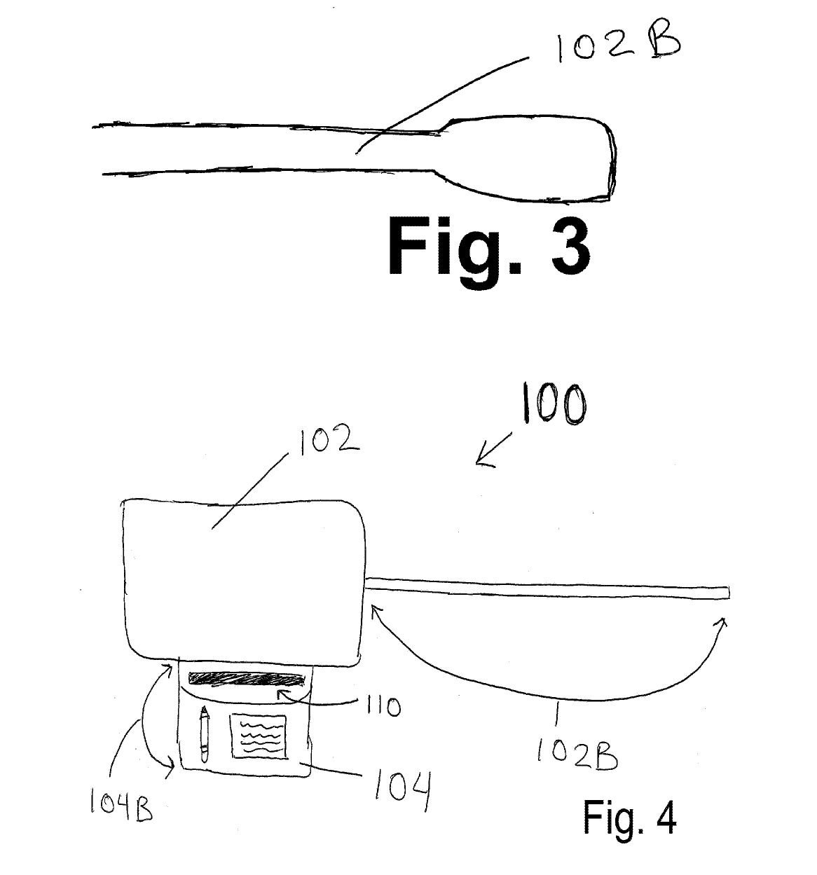

FIG. 3 shows how the end opposite of the marker body end of the elongate marker base and attachment member 102B can be of a increased thickness or width so that when a user places the roadside motor vehicle emergency marker 100 in some place like between a door it would provide increased resistance if someone were to try to pull it out. This increased thickness and/or width would serve as an obstacle from letting it slip through.

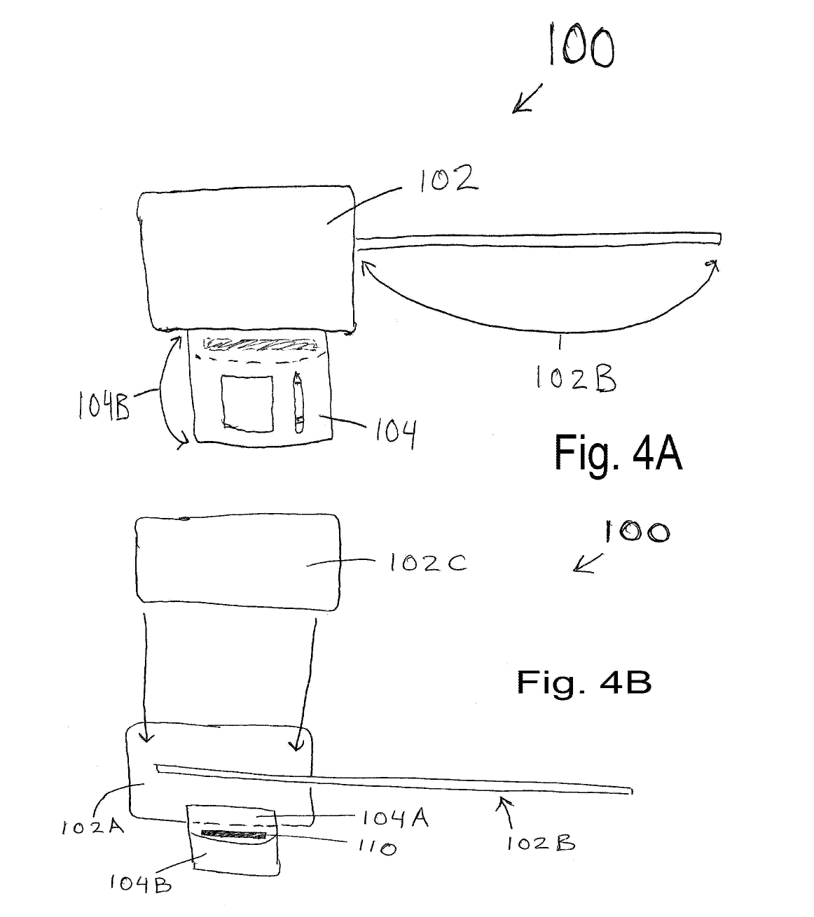

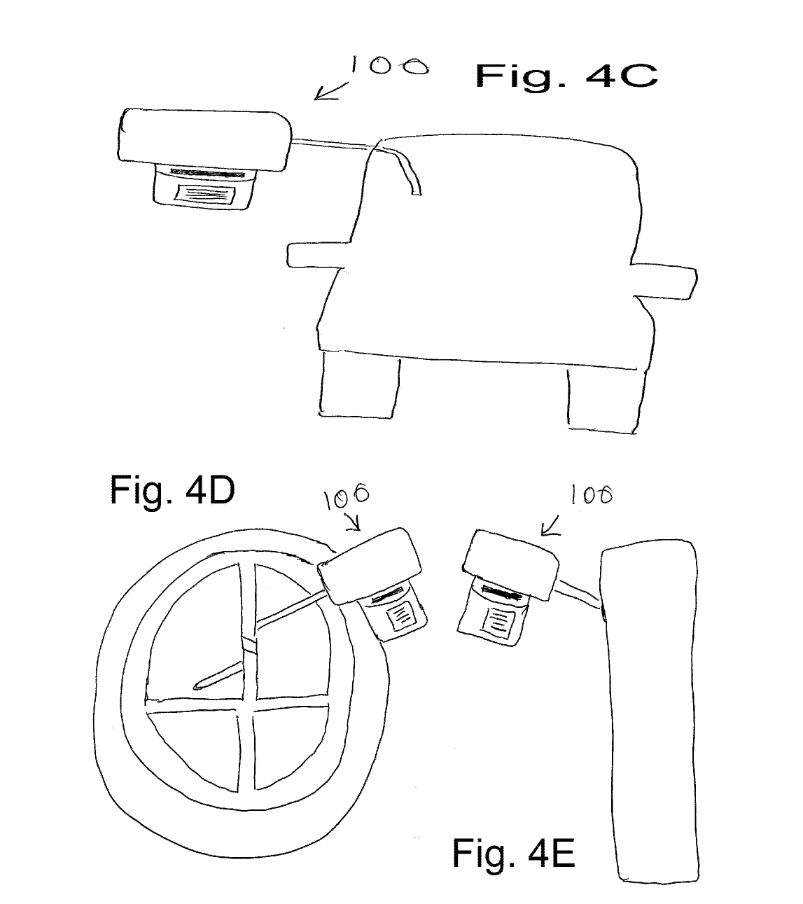

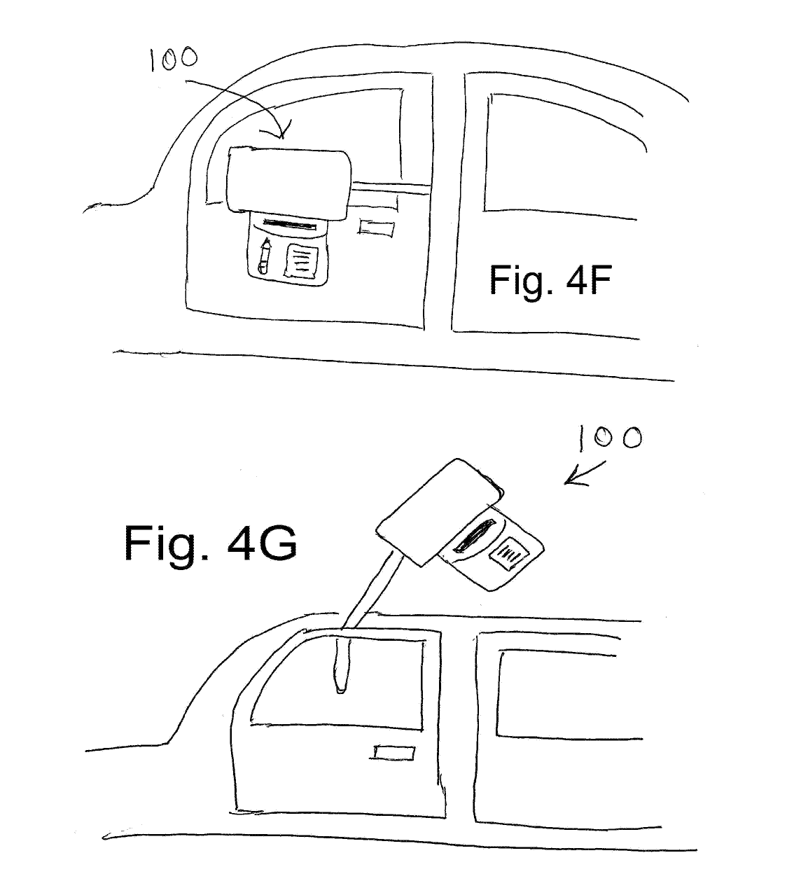

Another version of the roadside motor vehicle emergency with information display 100 is shown in FIG. 4 through FIG. 4G. This version is the same as the version shown in FIG. 1 through FIG. 1J but the elongate marker base and attachment member 102B is a rod. The message sleeve 104 has velcro as the selfseal 110 instead of a zipper.

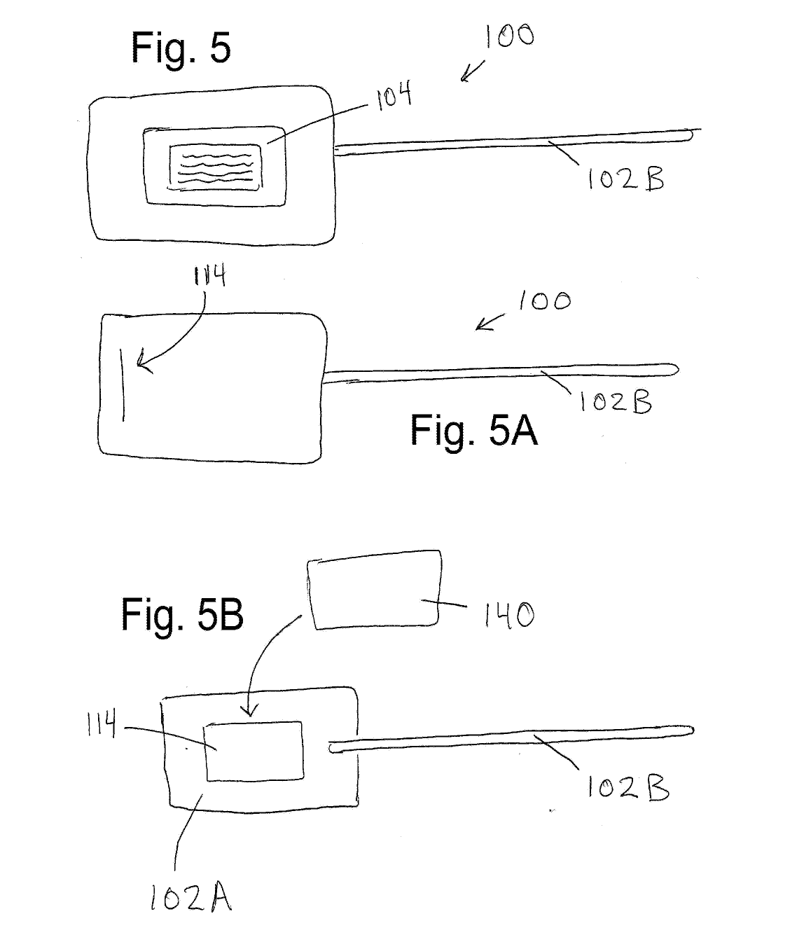

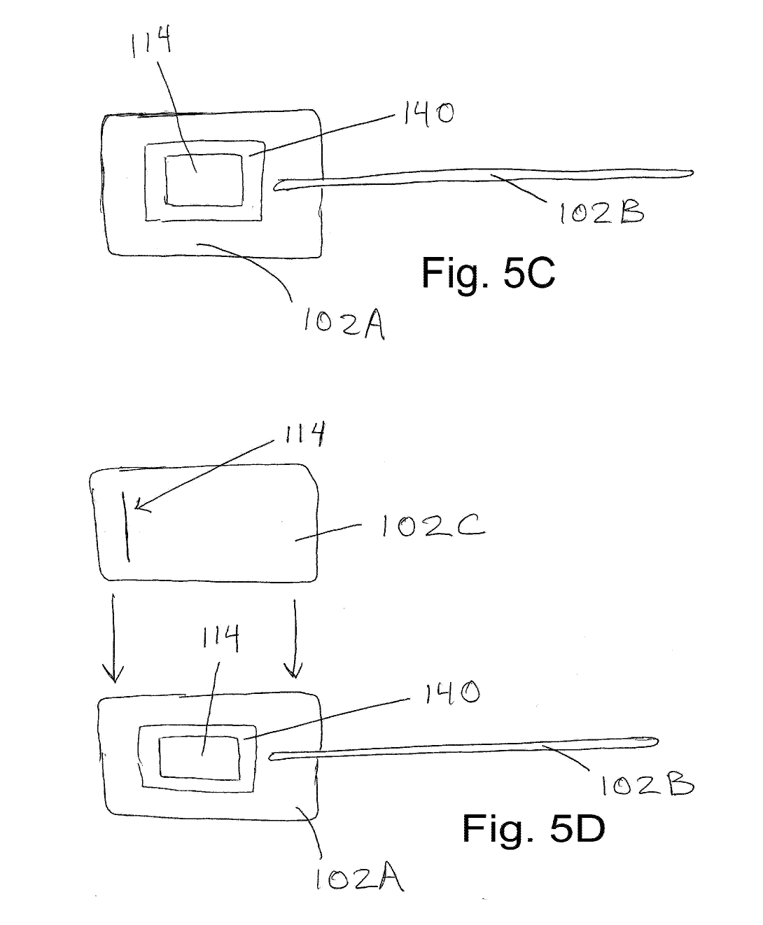

Another version of the roadside motor vehicle emergency with information display 100 is shown in FIG. 5 through FIG. 5D. This version is the same as the version shown in FIG. 2 through FIG. 2G but the elongate marker base and attachment member 102B is a rod.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A roadside emergency marker comprising:
an attachment member for the releasable affixation to a motor vehicle component;
an flexible, elongate base, affixed to said attachment member, adapted to form a angled projection relative to said attachment member;
a substantially planar reflective marker body distally affixed to said base;
a message sleeve, contacting said marker body, with a message reservoir adapted to selectively selfseal.

2. The marker of claim 2 wherein said base includes a rod.

3. The marker of claim 2 wherein said body is collapsible.

4. The marker of claim 1 wherein said sleeve is integral to, and positioned within, said body; and said body includes a substantially transparent surface portion.
